(19) United States
(12) Patent Application Publication
(10) Pub. No.: US 2018/0040404 A1
(43) Pub. Date: Feb. 8, 2018

(54) RARE-EARTH NANOCOMPOSITE MAGNET

(71) Applicants: TOYOTA JIDOSHA KABUSHIKI KAISHA, Toyota-shi (JP); NATIONAL INSTITUTE FOR MATERIALS SCIENCE, Tsukuba-shi (JP)

(72) Inventors: Hidefumi KISHIMOTO, Susono-shi (JP); Noritsugu SAKUMA, Susono-shi (JP); Masao YANO, Sunto-gun (JP); Weibin CUI, Tsukuba-shi (JP); Yukiko TAKAHASHI, Tsukuba-shi (JP); Kazuhiro HONO, Tsukuba-shi (JP)

(73) Assignees: TOYOTA JIDOSHA KABUSHIKI KAISHA, Toyota-shi (JP); NATIONAL INSTITUTE FOR MATERIALS SCIENCE, Tsukuba-shi (JP)

(21) Appl. No.: 15/784,975

(22) Filed: Oct. 16, 2017

Related U.S. Application Data
(63) Continuation of application No. 14/368,541, filed on Jun. 25, 2014, now Pat. No. 9,818,520.

(30) Foreign Application Priority Data
Jan. 4, 2012 (JP) 2012-000155

(51) Int. Cl. H01F 7/02; C22C 38/00; H01F 10/12; H01F 1/03

(52) U.S. Cl. CPC H01F 7/02; H01F 10/126; H01F 1/0311; C22C 38/005

(57) ABSTRACT

The invention provides a nanocomposite magnet, which has achieved high coercive force and high residual magnetization. The magnet is a non-ferromagnetic phase that is intercalated between a hard magnetic phase with a rare-earth magnet composition and a soft magnetic phase, wherein the non-ferromagnetic phase reacts with neither the hard nor soft magnetic phase. A hard magnetic phase contains Nd₂Fe₁₄B, a soft magnetic phase contains Fe or Fe₂Co, and a non-ferromagnetic phase contains Ta. The thickness of the non-ferromagnetic phase containing Ta is 5 nm or less, and the thickness of the soft magnetic phase containing Fe or Fe₂Co is 20 nm or less. Nd, or Pr, or an alloy of Nd and any one of Cu, Ag, Al, Ga, and Pr, or an alloy of Pr and any one of Cu, Ag, Al, and Ga is diffused into a grain boundary phase of the hard magnetic phase of Nd₂Fe₁₄B.

### TECHNICAL FIELD

The present invention relates to a nanocomposite magnet having a hard magnetic phase with a rare-earth magnet composition and a soft magnetic phase.

### BACKGROUND ART

A rare-earth nanocomposite magnet, in which a hard magnetic phase with a rare-earth magnet composition and a soft magnetic phase are mixed up together in a nano size (several nm to several tens of nm), can achieve high residual magnetization, coercive force, and maximum energy product owing to exchange interaction acting between a hard magnetic phase and a soft magnetic phase.

However a texture having both a hard magnetic phase and a soft magnetic phase has had a drawback in that magnetization reversal occurs in a soft magnetic phase and propagation of the magnetization reversal cannot be prevented which leads to low coercive force.

As a countermeasure, a nanocomposite magnet, in which the residual magnetization and coercive force are improved by forming a 3-phase texture with an intercalated R-Cu alloy phase (thickness unknown, R is one, or 2 or more kinds of rare-earth elements) between a Nd₂Fe₁₄B phase (hard magnetic phase) and an α-Fe phase (soft magnetic phase), and thereby preventing the magnetization reversal from propagation, is disclosed in Patent Literature 1.

However, there is another drawback in the texture according to Patent Literature 1, in that the R-Cu phase intercalated between a hard magnetic phase and a soft magnetic phase impedes exchange coupling between a hard magnetic phase and a soft magnetic phase, and moreover the intercalated R-Cu phase reacts with both the hard magnetic phase and the soft magnetic phase so as to extend the distance between the hard soft phase and the soft phase and inhibit good exchange coupling, resulting in low residual magnetization.

### CITATION LIST

### Patent Literature

[Patent Literature 1] Japanese Laid-open Patent Publication No. 2005-93731

### SUMMARY OF INVENTION

### Technical Problem

An object of the present invention is to provide a nanocomposite magnet, which has overcome the drawback in the conventional art, achieved both high coercive force and residual magnetization, and also improved maximum energy product.

### Solution to Problem

In order to achieve the object, the present invention provides a rare-earth nanocomposite magnet characterized in that a non-ferromagnetic phase is intercalated between a hard magnetic phase with a rare-earth magnet composition and a soft magnetic phase, wherein the non-ferromagnetic phase reacts with neither the hard magnetic phase nor the soft magnetic phase. The term “non-ferromagnetic phase” means herein a substance not having ferromagnetism, namely a substance not having a character to exhibit spontaneous magnetization even without an external magnetic field.

### Advantageous Effects of Invention

In a rare-earth nanocomposite magnet according to the present invention, a non-ferromagnetic phase intercalated between a hard magnetic phase and a soft magnetic phase as a spacer, which does not react with neither a hard magnetic phase nor a soft magnetic phase, prevents magnetization reversal occurred in the soft magnetic phase or a region with low coercive force from propagation, to suppress magnetization reversal of the hard magnetic phase, so that high coercive force can be achieve, while securing high residual magnetization.

### BRIEF DESCRIPTION OF DRAWINGS

FIG. 1 is (1) a schematic diagram, and (2) a TEM micrograph of a cross-sectional structure of a rare-earth nanocomposite magnet according to the present invention formed to a film in Example 1.

FIG. 2 is a magnetization curve of a rare-earth nanocomposite magnet according to the present invention having the structure of FIG. 1. The directions of an applied magnetic field are vertical (filled circle) and parallel (filled square) to the surface of a thin film sample.

FIG. 3 is (1) a schematic diagram, and (2) a TEM micrograph of a cross-sectional structure of a rare-earth nanocomposite magnet according to the present invention formed to a film in Example 2.

FIG. 4 is a magnetization curve of a rare-earth nanocomposite magnet according to the present invention having the structure of FIG. 3. The directions of an applied magnetic field are vertical (filled circle) and parallel (filled square) to the surface of a thin film sample.

FIG. 5 is a schematic diagram of a cross-sectional structure of a rare-earth nanocomposite magnet according to the present invention formed to a film in Example 3.

FIG. 6 is a TEM micrograph of a cross-sectional structure of a rare-earth nanocomposite magnet according to the present invention formed to a film in Example 3.

FIG. 7 is a magnetization curve of a rare-earth nanocomposite magnet according to the present invention having the structure of FIG. 5 and FIG. 6. The directions of an applied magnetic field are vertical (filled circle) and parallel (filled square) to the surface of a thin film sample.

FIG. 8 is (1) a schematic diagram, and (2) a TEM micrograph of a cross-sectional structure of a conventional rare-earth nanocomposite magnet formed to a film in Comparative Example.

FIG. 9 is a magnetization curve of a conventional rare-earth nanocomposite magnet having the structure of FIG. 8. The direction of an applied magnetic field is vertical to the surface of a thin film sample.

FIG. 10 is a schematic diagram of a cross-sectional structure (1) of a rare-earth nanocomposite magnet according to the present invention formed to a film in Example 4.

FIG. 11 is (1) a graph representing change of residual magnetization with the thickness of a Ta phase, and (2) a graph representing relationships between maximum energy product and the thickness of a Ta phase and a Fe₂Co phase.

### DESCRIPTION OF EMBODIMENTS

A rare-earth nanocomposite magnet according to the present invention has a texture, wherein between a hard magnetic phase with a rare-earth magnet composition and a soft magnetic phase, a non-ferromagnetic phase is intercalated, which reacts with neither the hard magnetic phase nor the soft magnetic phase.

Typically, a rare-earth nanocomposite magnet according to the present invention is a rare-earth nanocomposite magnet with a Nd₂Fe₁₄B based composition, in which a hard magnetic phase is composed of Nd₂Fe₁₄B, a soft magnetic phase is composed of Fe or Fe₂Co, and a non-ferromagnetic phase is composed of Ta. With this typical composition, when Fe₂Co is desirably used rather than Fe for a soft magnetic phase, the residual magnetization and the maximum energy product can be further enhanced.

With a typical composition, coercive force as high as 8 kOe or more can be achieved. As for residual magnetization, 1.50 T or more, desirably 1.55 T or more, and more desirably 1.60 T or more can be achieved.

With a typical composition, the thickness of a non-ferromagnetic phase composed of Ta is desirably 5 nm or less. When the thickness of a non-ferromagnetic phase is restricted to 5 nm or less, the exchange coupling action can be enhanced and the residual magnetization can be further improved. Further, when the thickness of a soft magnetic phase composed of Fe or Fe₂Co is desirably, 20 nm or less, a high maximum energy product can be obtained stably.

With a typical composition, when any one of the following (1) to (4) is desirably diffused in a grain boundary phase of a hard magnetic phase of Nd2Fe14B:

(1) Nd,

(2) Pr,

(3) an alloy of Nd, and any one of Cu, Ag, Al, Ga, and Pr, and

(4) an alloy of Pr, and any one of Cu, Ag, Al, and Ga,

a higher coercive force can be obtained.

### EXAMPLES

Nd₂Fe₁₄B based rare-earth nanocomposite magnets were produced according to typical compositions of the present invention.

### Example 1

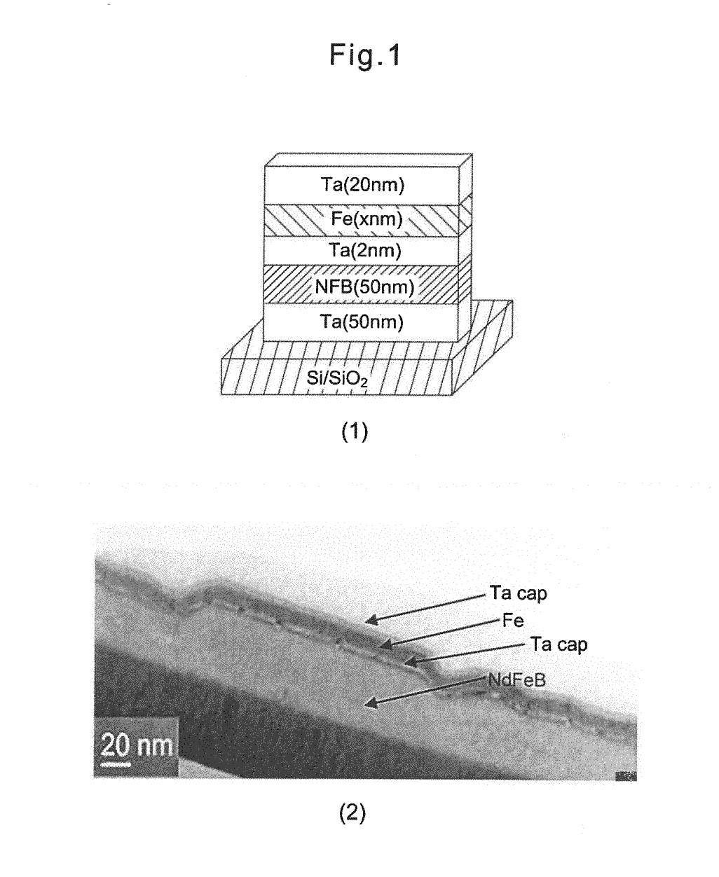

A film with the structure illustrated schematically in FIG. 1 (1) was formed by sputtering on a thermally-oxidized film (SiO₂) of a Si single crystal substrate. The conditions for film forming were as follows. In FIG. 1 (1) “NFB” stands for Nd₂Fe₁₄B.

### <Film Forming Conditions>

A) lower Ta layer: formed at room temperature

B) Nd₂Fe₁₄B layer: film formation at 550° C.+annealing at 600° C. for 30min

C) Ta spacer layer (intercalated layer)+α-Fe layer+Ta cap layer: film formation between 200 to 300° C.

wherein the Nd₂Fe₁₄B layer of B) is a hard magnetic phase, the Ta spacer layer of C) is an intercalated layer between a hard magnetic phase and a soft magnetic phase, and the α-Fe layer of C) is a soft magnetic phase.

A TEM micrograph of a cross-sectional structure of the obtained nanocomposite magnet is shown in FIG. 1 (2).

### <Evaluation of Magnetic Properties>

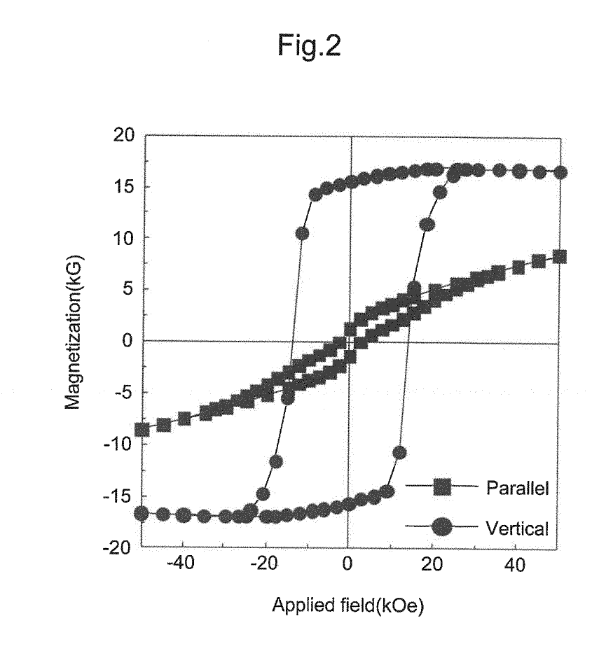

The magnetization curve of the nanocomposite magnet produced in the current Example is shown in FIG. 2.

The directions of an applied magnetic field are vertical (plotted as filled circles in the Figure) and parallel (plotted as filled squares in the Figure) to the surface of a formed film.

Coercive force of 14 kOe, residual magnetization of 1.55 T, and maximum energy product of 51 MGOe were obtained in the vertical direction to the formed film surface. The magnetic properties were measured by a VSM (Vibrating Sample Magnetometer). The same holds for other Examples and Comparative Example.

### Example 2

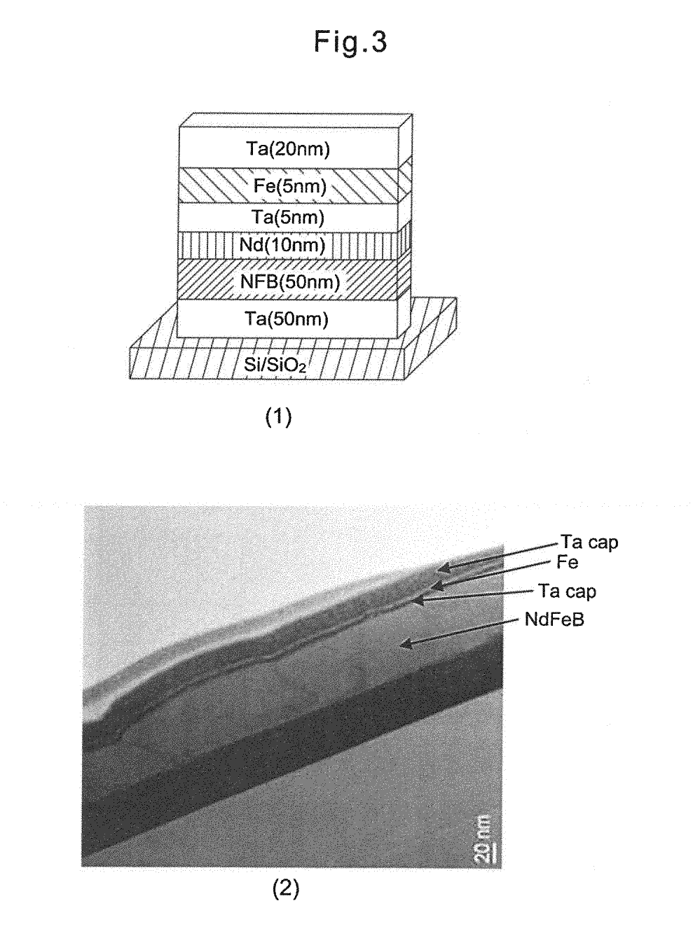

A film with the structure illustrated schematically in FIG. 3 (1) was formed by sputtering on a thermally-oxidized film (SiO₂) of a Si single crystal substrate. The conditions for film forming were as follows. In FIG. 3 (1) “NFB” stands for Nd₂Fe₁₄B.

### <Film Forming Conditions>

A) lower Ta layer: formed at room temperature

B′) Nd₂Fe₁₄B layer+Nd layer: film formation at 550° C.+annealing at 600° C. for 30min

C) Ta spacer layer (intercalated layer)+α-Fe layer+Ta cap layer: film formation between 200 to 300° C.

wherein the Nd₂Fe₁₄B layer of B′) is a hard magnetic phase, the Ta spacer layer of C) is an intercalated layer between a hard magnetic phase and a soft magnetic phase, and the α-Fe layer of C) is a soft magnetic phase.

The Nd layer formed on the Nd₂Fe₁₄B layer was diffused and infiltrated into a grain boundary phase of a Nd₂Fe₁₄B phase during annealing.

A TEM micrograph of a cross-sectional structure of the obtained nanocomposite magnet is shown in FIG. 3 (2).

### <Evaluation of Magnetic Properties>

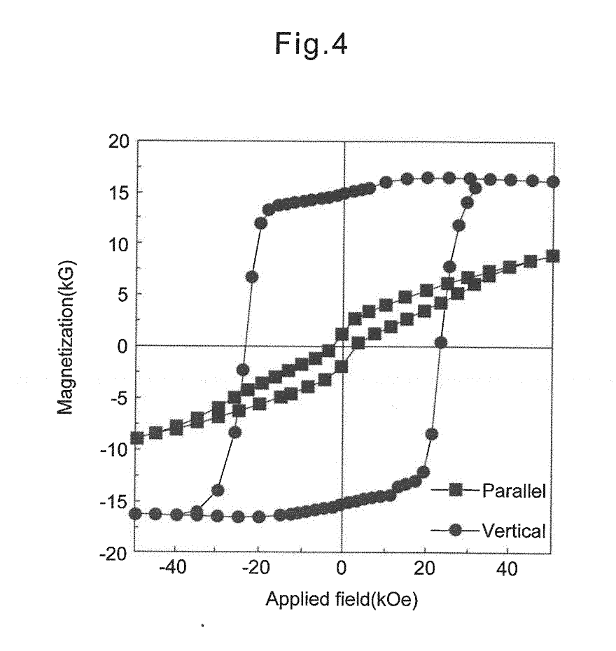

The magnetization curve of the nanocomposite magnet produced in the current Example is shown in FIG. 4.

The directions of an applied magnetic field are vertical (plotted as filled circles in the Figure) and parallel (plotted as filled squares in the Figure) to the surface of a formed film.

Coercive force of 23.3 kOe, residual magnetization of 1.5 T, and maximum energy product of 54 MGOe were obtained in the vertical direction to the formed film surface.

In the current Example, a higher coercive force compared to Example 1 could be obtained by diffusion of Nd into a grain boundary phase of a Nd₂Fe₁₄B phase. As a diffusing component, in addition to Nd, also a Nd-Ag alloy, a Nd-Al alloy, a Nd-Ga alloy, and a Nd-Pr alloy can be utilized.

### Example 3

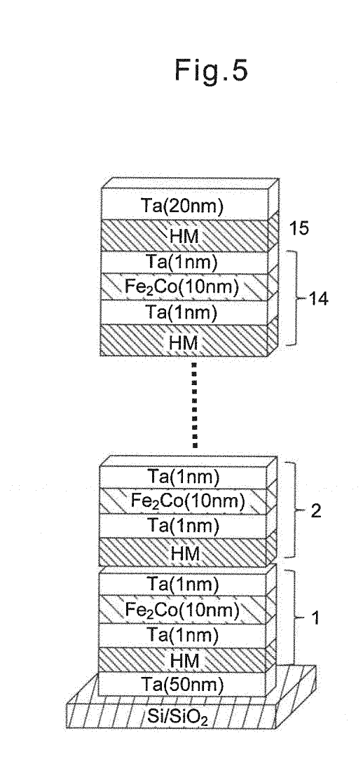

A film with the structure illustrated schematically in FIG. 5 was formed by sputtering on a thermally-oxidized film (SiO₂) of a Si single crystal substrate. The conditions for film forming were as follows. In FIG. 5 “HM” stands for Nd₂Fe₁₄B layer (30 nm)+Nd layer (3 nm).

### <Film Forming Conditions>

A) lower Ta layer: formed at room temperature

B′) Nd₂Fe₁₄B layer+Nd layer: film formation at 550° C.+annealing at 600° C. for 30min

C) Ta spacer layer+Fe₂Colayer+Ta cap layer: film formation between 200 to 300° C.

wherein the Nd₂Fe₁₄B layer of B) is a hard magnetic phase, the Ta spacer layer of C) is an intercalated layer between a hard magnetic phase and a soft magnetic phase, and the Fe₂Co layer of C) is a soft magnetic phase.

As illustrated in FIG. 5, in the 1st cycle, the above A)+B′)+C) were conducted, then in the 2nd to 14th cycles B′)+C) were repeated, and in the 15th cycle B′)+film formation of Ta cap layer were conducted. In other words, 15 HM layers (=Nd₂Fe₁₄B layer+Nd layer) were stacked. In each HM layer, a Nd layer formed on a Nd2Fe14B layer diffused and infiltrated into a grain boundary phase of a Nd₂Fe₁₄B phase during annealing.

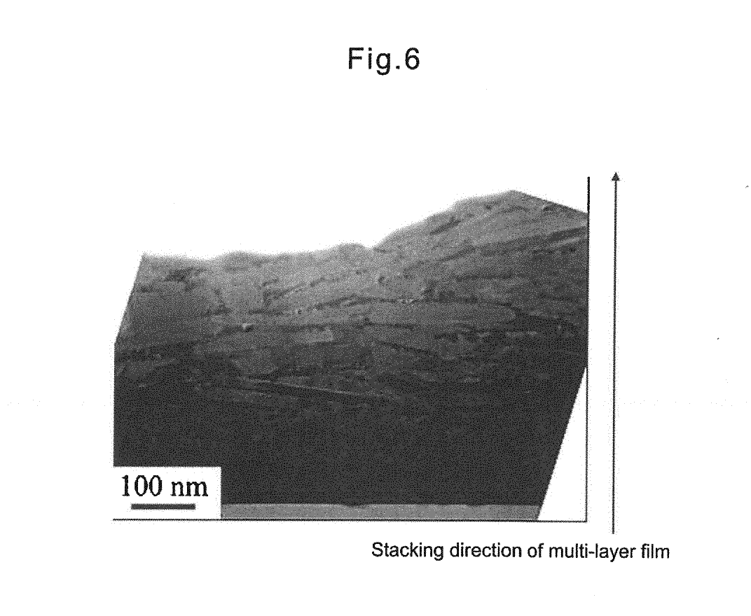

A TEM micrograph of a cross-sectional structure of the obtained nanocomposite magnet is shown in FIG. 6.

### <Evaluation of Magnetic Properties>

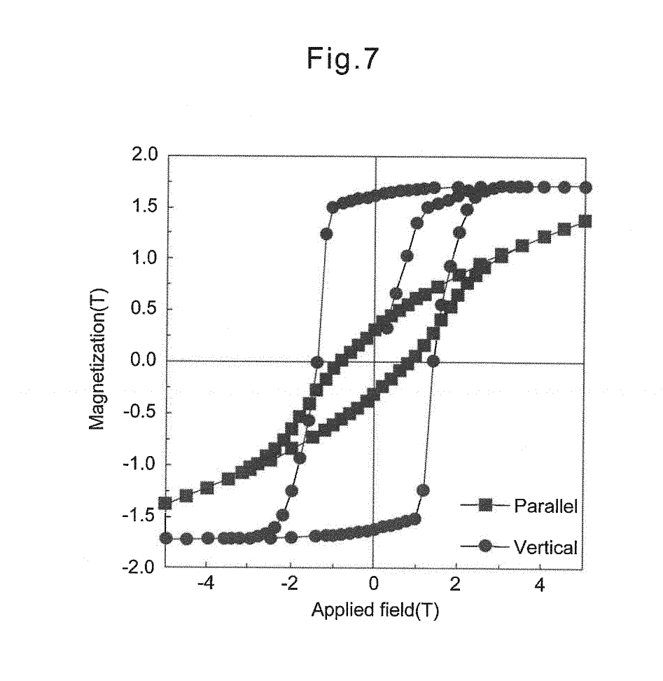

The magnetization curve of the nanocomposite magnet produced in the current Example is shown in FIG. 7.

The directions of an applied magnetic field are vertical (plotted as filled circles in the Figure) and parallel (plotted as filled squares in the Figure) to the surface of a formed film.

Coercive force of 14.3 kOe, residual magnetization of 1.61 T, and maximum energy product of 62 MGOe were obtained in the vertical direction to the formed film surface. In particular, the value 1.61 T of residual magnetization exceeds a theoretical residual magnetization value of a single phase texture of Nd₂Fe₁₄B.

### Comparative Example

As a Comparative Example, a conventional Nd₂Fe₁₄B based rare-earth nanocomposite magnet, in which a non-ferromagnetic phase according to the present invention was not intercalated between a hard magnetic phase and a soft magnetic phase, was produced.

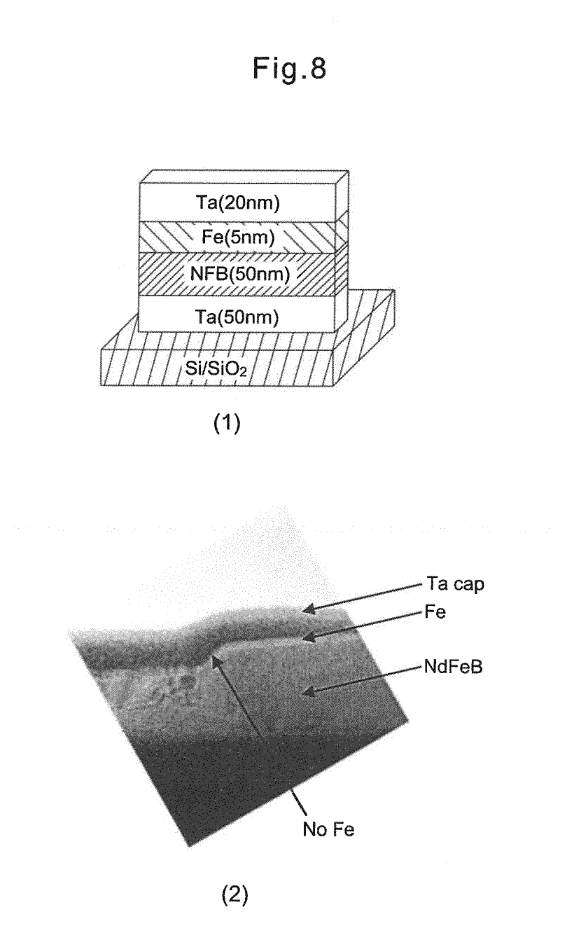

A film with the structure illustrated schematically in FIG. 8 (1) was formed by sputtering on a thermally-oxidized film (SiO₂) of a Si single crystal substrate. The conditions for film forming were as follows. In FIG. 8 (1) “NFB” stands for Nd₂Fe₁₄B.

### <Film Forming Conditions>

A) lower Ta layer: formed at room temperature

B) Nd₂Fe₁₄B layer: film formation at 550° C.+annealing at 600° C. for 30min

C) α-Fe layer+Ta cap layer: film formation between 200 to 300° C.

wherein the Nd₂Fe₁₄B layer of B) is a hard magnetic phase, and the α-Fe layer of C) is a soft magnetic phase.

A TEM micrograph of a cross-sectional structure of the obtained nanocomposite magnet is shown in FIG. 8 (2). There is not a non-ferromagnetic phase (Ta phase) intercalated between a Nd2Fe14B layer as a hard magnetic phase and an α-Fe layer as a soft magnetic phase. As remarked in FIG. 8 (2) as “No Fe”, an α-Fe layer as a soft magnetic phase has disappeared by diffusion at some region. At the region, a nanocomposite magnet structure is broken.

### <Evaluation of Magnetic Properties>

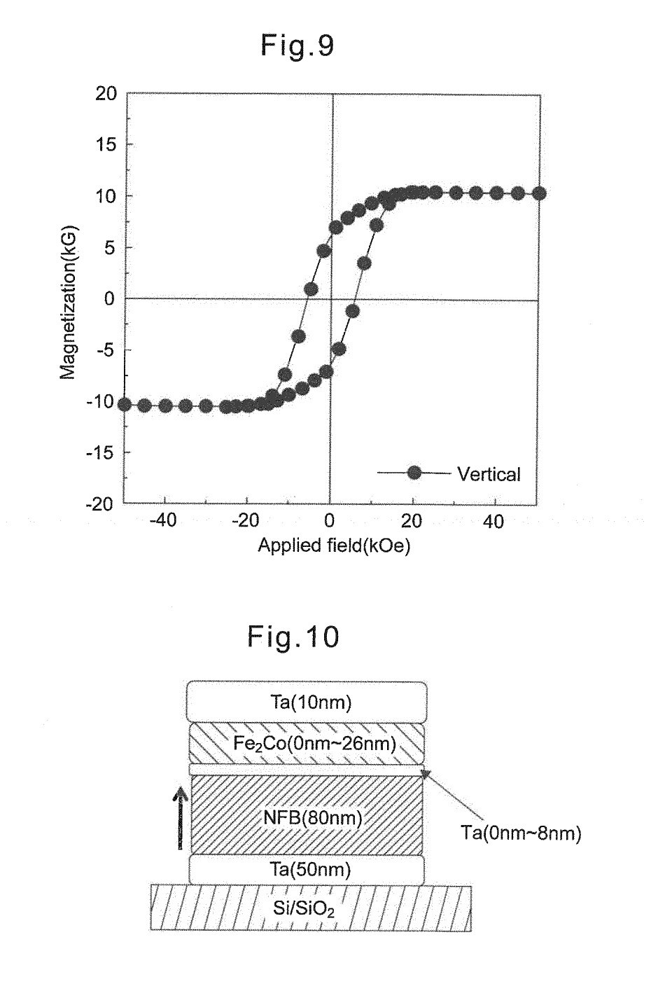

The magnetization curve of the nanocomposite magnet produced in the current Comparative Example is shown in FIG. 9.

The directions of an applied magnetic field is vertical to the formed film surface.

Coercive force of 6 kOe, residual magnetization of 0.7 T, and maximum energy product of 6 MGOe were obtained in the vertical direction to the formed film surface.

The magnetic properties obtained in the Comparative Example and Examples 1 to 3 are summarized in Table 1.

TABLE 1
Results of Magnetic Properties

| | | |
|---|---|---|
| | | Maximum |
| Coercive | Residual | Energy |
| Force | Magnetization | Product |

| | | | | | | |
|---|---|---|---|---|---|---|
| Comparative | 6 | kOe | 0.7 | T | 6 | MGOe |
| Example | | | | | | |
| Example 1 | 14 | kOe | 1.55 | T | 51 | MGOe |
| Example 2 | 23.3 | kOe | 1.5 | T | 54 | MGOe |
| Example 3 | 14.3 | kOe | 1.61 | T | 62 | MGOe |

As obvious from Table 1, with respect to Nd₂Fe₁₄B based rare-earth nanocomposite magnets, in which combinations of components of a hard magnetic phase and a soft magnetic phase are equivalent, a texture according to the present invention including a non-ferromagnetic phase intercalated between the hard magnetic phase and the soft magnetic phase has improved significantly all of coercive force, residual magnetization, and maximum energy product, compared to a texture according to a conventional art not having a non-ferromagnetic phase intercalated between the hard magnetic phase and the soft magnetic phase.

### Example 4

Influences of the thickness of a non-ferromagnetic phase Ta and the thickness of a soft magnetic phase Fe₂Co in a structure according to the present invention were examined. Further, for comparison, case without a Ta layer or a Fe₂Co layer were also examined.

A film with the structure illustrated schematically in FIG. 10 was formed by sputtering on a thermally-oxidized film (SiO₂) of a Si single crystal substrate. The conditions for film forming were as follows. In FIG. 10 “NFB” stands for Nd₂Fe₁₄B.

### <Film Forming Conditions>

A) lower Ta layer: formed at room temperature

B) Nd₂Fe₁₄B layer: film formation at 550° C.+annealing at 600° C. for 30 min

C′) Ta spacer layer+α-Fe layer+Ta cap layer: film formation between 200 to 300° C.

wherein the Nd₂Fe₁₄B layer of B) is a hard magnetic phase, the Ta spacer layer of C′) is an intercalated layer between a hard magnetic phase and a soft magnetic phase, and the α-Fe layer of C′) is a soft magnetic phase.

Thickness of Ta spacer layer: 0 nm to 8 nm

Thickness of Fe₂Co layer: 0 nm to 26 nm

The thicknesses of a non-ferromagnetic phase Ta and a soft magnetic phase Fe₂Co were measured by a transmission electron micrograph (TEM).

### <Influence of Ta Spacer Layer>

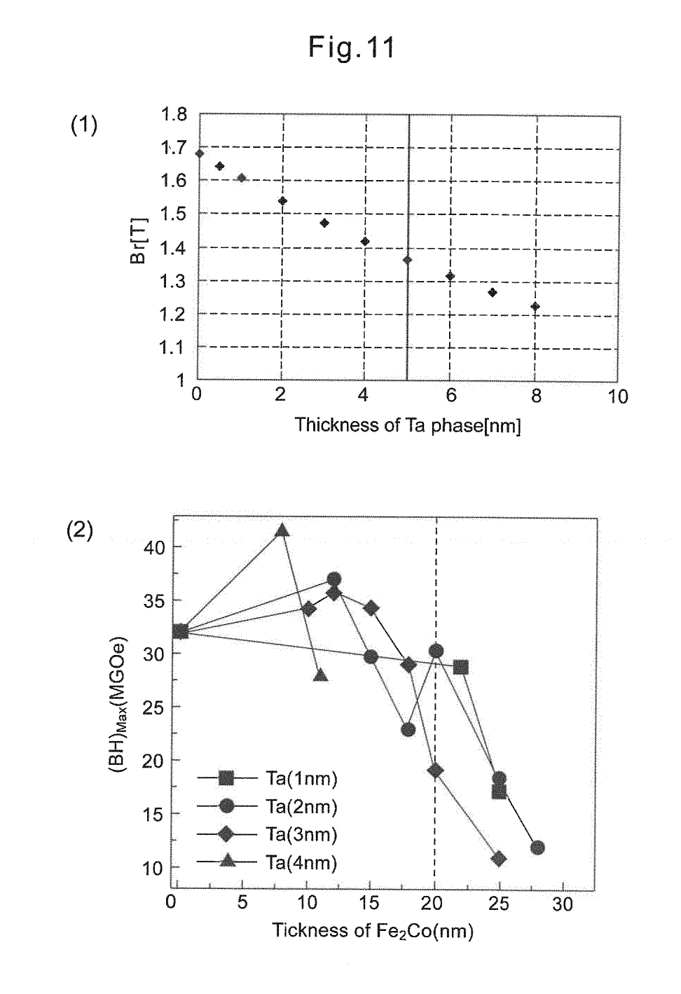

Change of residual magnetization Br, when the thickness of a Ta spacer layer as a non-ferromagnetic phase intercalated between a hard magnetic phase and a soft magnetic phase is changed, is shown in FIG. 11 (1). With increase of the thickness of the non-ferromagnetic phase, the volume fraction of a region generating magnetism decreases, and therefore residual magnetization decreases monotonically. To generate practical residual magnetization, it is appropriate to select the thickness of the Ta spacer layer as a non-ferromagnetic phase at 5 nm or less.

Change of maximum energy product, when the thickness of a Fe₂Co layer as a soft magnetic phase is changed, is shown in FIG. 11 (2). As seen in the Figure, when the thickness of a soft magnetic phase exceeds 20 nm, the maximum energy product decreases sharply. Presumably, this is because magnetization reversal occurred more easily due to existence of a soft magnetic phase beyond exchange interaction length, which made coercive force and residual magnetization decrease.

Therefore the thickness of a Fe₂Co layer as a soft magnetic phase is preferably 20 nm or less.

### INDUSTRIAL APPLICABILITY

The present invention provides a nanocomposite magnet, which has achieved both high coercive force and high residual magnetization, and also improved maximum energy product.

1-5. (canceled)

6. A rare-earth nanocomposite magnet film wherein a non-ferromagnetic phase is intercalated between a hard magnetic phase with a rare-earth magnet composition and a soft magnetic phase, wherein the non-ferromagnetic phase reacts with neither the hard magnetic phase nor the soft magnetic phase, and wherein the non-ferromagnetic phase comprises Ta.

7. The rare-earth nanocomposite magnet film according to claim 6 wherein the hard magnetic phase comprises Nd₂Fe₁₄B, the soft magnetic phase comprises Fe or Fe₂Co, and the non-ferromagnetic phase comprises Ta.

8. The rare-earth nanocomposite magnet film according to claim 7 wherein the thickness of the non-ferromagnetic phase comprising Ta is 5 nm or less.

9. The rare-earth nanocomposite magnet film according to claim 7 wherein the thickness of the soft magnetic phase comprising Fe or Fe₂Co is 20 nm or less.

10. The rare-earth nanocomposite magnet film according to claim 7 wherein any one of the following (1) to (4) is diffused in a grain boundary phase of the hard magnetic phase comprising Nd₂Fe₁₄B:
(1) Nd,
(2) Pr,
(3) an alloy of Nd, and any one of Cu, Ag, Al, Ga, and Pr, and
(4) an alloy of Pr, and any one of Cu, Ag, Al, and Ga.

11. The rare-earth nanocomposite magnet film according to claim 8 wherein the thickness of the soft magnetic phase comprising Fe or Fe₂Co is 20 nm or less.

12. The rare-earth nanocomposite magnet film according to claim 8 wherein any one of the following (1) to (4) is diffused in a grain boundary phase of the hard magnetic phase comprising Nd₂Fe₁₄B:
(1) Nd,
(2) Pr,
(3) an alloy of Nd, and any one of Cu, Ag, Al, Ga, and Pr, and
(4) an alloy of Pr, and any one of Cu, Ag, Al, and Ga.

13. The rare-earth nanocomposite magnet film according to claim 9 wherein any one of the following (1) to (4) is diffused in a grain boundary phase of the hard magnetic phase comprising Nd₂Fe₁₄B:
(1) Nd,
(2) Pr,
(3) an alloy of Nd, and any one of Cu, Ag, Al, Ga, and Pr, and
(4) an alloy of Pr, and any one of Cu, Ag, Al, and Ga.

14. The rare-earth nanocomposite magnet film according to claim 11 wherein any one of the following (1) to (4) is diffused in a grain boundary phase of the hard magnetic phase comprising Nd₂Fe₁₄B:
(1) Nd,
(2) Pr,
(3) an alloy of Nd, and any one of Cu, Ag, Al, Ga, and Pr, and
(4) an alloy of Pr, and any one of Cu, Ag, Al, and Ga.
